(19) United States
(12) Patent Application Publication
(10) Pub. No.: US 2025/0066611 A1
(43) Pub. Date: Feb. 27, 2025

(54) PIGMENT DISPERSANT, PIGMENT DISPERSION, AND AQUEOUS INK-JET INK COMPOSITION

(71) Applicant: SCREEN Holdings Co., Ltd., Kyoto (JP)

(72) Inventors: Maho KINOSHITA, Kyoto (JP); Ichiro SAKAI, Kyoto (JP)

(21) Appl. No.: 18/726,531

(22) PCT Filed: Nov. 4, 2022
(86) PCT No.: PCT/JP2022/041172

§ 371 Date: Jul. 3, 2024

(30) Foreign Application Priority Data
Jan. 6, 2022 (JP) 2022-001158

(51) Int. Cl. C09B 67/46; C09B 48/00; C09D 11/322; C09D 11/38

(52) U.S. Cl. CPC C09B 67/0086; C09B 48/00; C09D 11/322; C09D 11/38

(57) ABSTRACT

Provided are a pigment dispersant, a pigment dispersion, and an aqueous ink composition for inkjet that satisfactorily inhibit a magenta pigment from aggregating and makes it possible to obtain an aqueous ink applicable by printing in an inkjet system. The pigment dispersant of the present invention is a pigment dispersant for dispersing a magenta pigment, wherein a copolymer composed of a polymer alcohol and an ester, or an acrylic dispersant is dispersed in a dispersion medium, and the copolymer composed of the polymer alcohol and the ester, and the acrylic dispersant have an acid value.

### TECHNICAL FIELD

The present invention relates to a pigment dispersant, a pigment dispersion and an aqueous ink composition for inkjet, and particularly to a pigment dispersant, a pigment dispersion, and an aqueous ink composition for inkjet which are capable of, for example, inhibiting aggregation of a magenta pigment to be used for an aqueous ink for inkjet and improving the dispersibility of the magenta pigment.

### BACKGROUND ART

An aqueous ink to be used for printing in an inkjet system is required to have ejection stability with which an aqueous ink can be stably ejected without causing ejection failure of the aqueous ink caused by aggregation of a pigment. Furthermore, the aggregation of the pigment also occurs after printing on a recording medium using the aqueous ink. That is, there is a problem that after the droplets of the aqueous ink landed on the recording medium, the pigment aggregates, and as a result, the droplets do not sufficiently spread on the recording medium, the print density of the print image decreases, and the hue decreases.

In order to solve these problems, for example, Patent Document 1 discloses the use of a styrene-acrylic acid-methacrylic acid resin (styrene/acrylic acid/methacrylic acid=77/10/13) as a pigment dispersant for dispersing a quinacridone pigment. This pigment dispersant is adsorbed to the surface of the quinacridone pigment, and is intended to inhibit aggregation of the quinacridone pigment by repulsive force due to the steric hindrance of the pigment dispersant. However, this pigment dispersant does not necessarily attain dispersion at a satisfactory level in an aqueous ink to be used for printing in an inkjet system.

### PRIOR ART DOCUMENT

### Patent Document

Patent Document 1: JP 2000-186244 A

### SUMMARY OF THE INVENTION

### Problems to be Solved by the Invention

The present invention has been devised in view of the problems described above, and an object of the present invention is to provide a pigment dispersant, a pigment dispersion, and an aqueous ink composition for inkjet that satisfactorily inhibit a magenta pigment from aggregating and makes it possible to obtain an aqueous ink applicable by printing in an inkjet system.

### Solutions to the Problems

In order to solve the above-mentioned problems, a pigment dispersant according to the present invention is a pigment dispersant for dispersing a magenta pigment, wherein a copolymer composed of a polymer alcohol and an ester, or an acrylic dispersant is dispersed in a dispersion medium, and the copolymer composed of the polymer alcohol and the ester, and the acrylic dispersant have an acid value.

In the above configuration, it is preferred that the copolymer composed of a polymer alcohol and an ester, and the acrylic dispersant have no amine value.

In the above configuration, it is preferred that acid values of the copolymer composed of a polymer alcohol and an ester, and the acrylic dispersant are 10 mg KOH/g or more and 40 mg KOH/g or less.

In the above configuration, it is preferred that the copolymer composed of a polymer alcohol and an ester is a polyvinyl alcohol-polyacrylic acid copolymer.

In the above configuration, it is preferred that the polyvinyl alcohol-polyacrylic acid copolymer is DISPERBYK (registered trademark)-2096.

In the above configuration, it is preferred that the acrylic dispersant is DISPERBYK (registered trademark)-2015.

In order to solve the above-mentioned problems, a pigment dispersion according to the present invention comprises the pigment dispersant and the magenta pigment dispersed in the dispersion medium.

In the above configuration, it is preferred that the magenta pigment includes a quinacridone pigment.

In the above configuration, it is preferred that the quinacridone pigment includes at least one of C.I. Pigment Red 122 and C.I. Pigment Violet 19.

In order to solve the above-mentioned problems, an aqueous ink composition for inkjet according to the present invention comprises the pigment dispersion.

In the above configuration, it is preferable to comprises a humectant, wherein the humectant includes at least one of a trihydric or higher polyhydric alcohol and a glycol solvent.

In the above configuration, it is preferable to comprises a penetrant, wherein the penetrant includes at least one of a glycol ether and a heterocyclic compound.

### Effects of the Invention

In accordance with the present invention, by incorporating a substance being a copolymer of a polymer alcohol and an ester, or an acrylic dispersant and having an acid value in a pigment dispersant, it is possible to improve the effect of inhibiting a magenta pigment from aggregating as compared with conventional pigment dispersants. As a result, in the case of preparing an ink using the pigment dispersant with the above-described configuration as one of the raw materials, it becomes possible to obtain an aqueous ink composition for inkjet that is capable of satisfactorily dispersing a magenta pigment without allowing the magenta pigment to aggregate and suitable for printing in an inkjet system.

Incidentally, conventional aqueous ink compositions have a problem that the print density decreases due to aggregation of a pigment also after printing on a recording medium. That is, there is a problem that after the droplets of the aqueous ink landed on the recording medium, the pigment aggregates, and as a result, the droplets do not sufficiently spread on the recording medium, the print density of the print image decreases, and the hue decreases. However, as in the present invention, by incorporating a copolymer of a polymer alcohol and an ester or an acrylic dispersant not only having an acid value but also having no amine value into a pigment dispersant, it is possible to inhibit a magenta pigment from aggregating on a recording medium even after printing. As a result, reduction of the gamut of droplets of an aqueous ink composition can be decreased, and an aqueous ink composition capable of being printed at a good print density (color developability) can be realized. In addition, since the reduction of the gamut can be inhibited without changing the type of magenta pigment, the change in hue can also be prevented.

### BRIEF DESCRIPTION OF THE DRAWINGS

FIG. 1 is an L*a*b* color system chromaticity diagram of the print images produced using the aqueous ink compositions for inkjet according to Example 7 and Comparative Example 10.

FIG. 2 is a graph showing the measured values (L*, C*) of the print images produced using the aqueous ink compositions for inkjet according to Example 7 and Comparative Example 10.

FIG. 3 is an L*a*b* color system chromaticity diagram of the print images produced using the aqueous ink compositions for inkjet according to Examples 9 to 11 and Comparative Examples 7 to 9.

FIG. 4 is a graph showing the measured values (L*, C*) of the print images produced using the aqueous ink compositions for inkjet according to Examples 9 to 11 and Comparative Examples 7 and 8.

### EMBODIMENTS OF THE INVENTION

### (Pigment Dispersant)

The pigment dispersant according to the present embodiment will be described below.

The pigment dispersant of the present embodiment is formed by dispersing a copolymer composed of a polymer alcohol and an ester, or an acrylic dispersant in a dispersion medium. In addition, since the copolymer composed of a polymer alcohol and an ester, and the acrylic dispersant have an acid value and act so as to inhibit a magenta pigment aggregating, it is possible to realize an aqueous ink composition for inkjet (this may hereinafter be referred to as “aqueous ink composition”) that contains a magenta pigment dispersed well and is capable of being applied to printing in an inkjet system. Here, in the present description, the “inkjet system” means, for example, a printing system in which an aqueous ink composition is ejected in the form of droplets from a known piezoelectric inkjet head, the droplets are fixed to a recording medium, and a print image or the like is thereby formed. Details of the recording medium will be described later.

The acid values of the copolymer composed of a polymer alcohol and an ester, and the acrylic dispersant are preferably 75 mg KOH/g or less, and more preferably 10 mg KOH/g or more and 40 mg KOH/g or less. Setting the acid values to 75 mg KOH/g or less makes it possible to produce an aqueous ink composition with further improved dispersibility of a magenta pigment. When two or more types of the copolymer composed of a polymer alcohol and an ester or two or more types of the acrylic dispersant are used in combination, the acid value is determined as the average of the respective pigment dispersants. In the present description, the “acid value” means, for example, in the case of an acrylic dispersant, the mass (unit: mg) of potassium hydroxide (KOH) necessary for neutralizing free acid contained in 1 g of the solid content of the acrylic dispersant, and can be determined by a potentiometric titration method in accordance with JIS K 0070.

The copolymer composed of a polymer alcohol and an ester, and the acrylic dispersant of the present embodiment are not particularly limited as long as they have an acid value, but are preferably those having no amine value. As a result, a magenta pigment is inhibited from aggregating even on a recording medium after printing in an inkjet system, and as a result, the reduction of the color gamut of a print image can be decreased without changing the hue. In the present description, the “amine value” means, for example, in the case of an acrylic dispersant, the mass (unit: mg) of potassium hydroxide (KOH) equivalent to the amount of a base per 1 g of the solid content of the acrylic dispersant, and can be determined by a potentiometric titration method in accordance with JIS K 7237.

Examples of the copolymer composed of a polymer alcohol and an ester, the copolymer having an acid value and having no amine value, include a polyvinyl alcohol-polyacrylic acid copolymer. Further, as the polyvinyl alcohol-polyacrylic acid copolymer, for example, a commercially available product such as DISPERBYK (registered trademark)-2096 (acid value: 40 mg KOH/g) manufactured by BYK-Chemie GmbH can be used. In addition, DISPERBYK (registered trademark)-194N (acid value: 75 mg KOH/g) can also be used.

As the acrylic dispersant having an acid value and having no amine value, one member or two or more members selected from a polyacrylic acid (an acrylic acid polymer) and an acrylic acid copolymer can be suitably used. The polyacrylic acid is preferably one containing acrylic acid as a monomer component. The acrylic acid copolymer is preferably one in which, in addition to the acrylic acid, another monomer component such as styrene is copolymerized.

As the acrylic dispersant having an acid value and having no amine value, a commercially available product may be used, and examples thereof include DISPERBYK (registered trademark)-2015 (acid value: 10 mg KOH/g) manufactured by BYK-Chemie GmbH.

The molecular weights of the copolymer composed of a polymer alcohol and an ester, and the acrylic dispersant are not particularly limited, but are preferably set from the viewpoint of, for example, increasing the rate of adsorption to a magenta pigment.

The pigment dispersant according to the present embodiment includes a dispersion medium for dispersing a copolymer composed of a polymer alcohol and an ester or an acrylic dispersant. Examples of the dispersion medium include water, and more specifically include purified water such as ion-exchanged water, ultrafiltration water, reverse osmosis water, and distilled water, or water from which ionic impurities have been removed such as ultrapure water. In particular, water sterilized by ultraviolet irradiation, hydrogen peroxide addition, or the like is suitable because it can prevent generation of mold and bacteria for a long period of time. In addition, the content of the dispersion medium is not particularly limited, and may be appropriately set as necessary.

As the dispersion medium, a mixed solution of water and a water-soluble organic solvent may be used. The water-soluble organic solvent is not particularly limited, and examples thereof include ethyl alcohol, n-butyl alcohol, isobutyl alcohol, n-propyl alcohol, isopropyl alcohol, acetone, propylene glycol, polyethylene glycol, and glycerin. Furthermore, the blending amount in the case of using the water-soluble organic solvent in combination as the dispersion medium is not particularly limited, and may be appropriately set as necessary.

The content of the copolymer composed of a polymer alcohol and an ester or the acrylic dispersant is preferably 50 mass % or more and 100 mass % or less, more preferably 65 mass % or more and 100 mass % or less, and particularly preferably 80 mass % or more and 100 mass % or less based on the entire mass of the pigment dispersant. Owing to setting the content to 50 mass % or more, it is possible to improve the saturation, and particularly when the content is 80 mass % or more, this effect is more remarkable.

### (Pigment Dispersion and Method for Producing the Same)

Next, the pigment dispersion according to the present embodiment will be described below.

The pigment dispersion of the present embodiment can be used, for example, in an aqueous ink composition suitable for printing in an inkjet system, and comprises at least the above-described pigment dispersant and a pigment composed of a magenta pigment dispersed in the dispersion medium.

In the present embodiment, the pigment is composed of a magenta pigment to be used for printing in an inkjet system. By using the pigment, light resistance and water resistance can be improved as compared with the case of using a dye as a coloring material. The magenta pigment is not particularly limited, but in the present embodiment, a quinacridone pigment as an organic pigment is preferable.

The quinacridone pigment is not particularly limited, and examples thereof include C.I. Pigment Red 122, C.I. Pigment Red 202, C.I. Pigment Red 206, C.I. Pigment Red 207, C.I. Pigment Red 209, and C.I. Pigment Violet 19. Among these quinacridone pigments, C.I. Pigment Red 122 and C.I. Pigment Violet 19 are preferable from the viewpoint of saturation characteristics.

The content of the pigment affects the image density, and the storage stability, viscosity, pH, and the like of the aqueous ink composition. Therefore, the content of the pigment is preferably appropriately set in consideration of these points. More specifically, the content of the pigment is preferably in a range of 1 mass % to 10 mass % in terms of solid content based on the entire mass of the aqueous ink composition, more preferably in a range of 3 mass % to 10 mass %, and particularly preferably in a range of 4.5 mass % to 7 mass %. Owing to setting the content of the coloring material to 1 mass % or more, it is possible to inhibit decrease in image density, and in particular, when the content of the coloring material is 4.5% by mass or more, this effect is more remarkable. On the other hand, owing to setting the content of the coloring material to 10 mass % or less, it is possible to prevent deterioration in ejection property due to clogging of a nozzle, and in particular, when the content of the coloring material is 7 mass % or less, this effect is more remarkable.

The content of the copolymer composed of a polymer alcohol and an ester or the acrylic dispersant contained in the pigment dispersion may be set appropriately from the viewpoint of improvement in the dispersibility of the magenta pigment, and the like. In the case of the present embodiment, the content of these compounds is preferably 1 mass % or more and 50 mass % or less based on 100 mass % of the magenta pigment, and more preferably 1 mass % or more and 25 mass % or less. Owing to setting the content to 1 mass % or more, the dispersibility of the magenta pigment in the dispersion medium can be favorably maintained. On the other hand, owing to setting the content to 50 mass % or less, for example, when the pigment dispersion of the present embodiment is used in an aqueous ink composition, the viscosity of the aqueous ink composition can be inhibited from excessively increasing, and good ejection stability can be maintained. In particular, when the content is 25 mass % or less, this effect is more remarkable.

In the method for producing a pigment dispersion of the present embodiment, the mixing method and addition order of the magenta pigment, the pigment dispersant, and other additives blended as necessary are not particularly limited. For example, the magenta pigment, the pigment dispersant, water as a dispersion medium, and so on may be mixed at one time, and this mixed liquid may be subjected to a dispersion treatment using an ordinary dispersing machine.

The dispersion time in the dispersion treatment is not particularly limited, and may be appropriately set as necessary. The dispersing machine to be used in the dispersion treatment for the magenta pigment is not particularly limited as long as it is a dispersing machine commonly used. Examples thereof specifically include a ball mill, a roll mill, a sand mill, a bead mill, a paint shaker, and a Nanomizer.

The pigment dispersion of the present embodiment includes not only a form of an aqueous ink composition (details will be described later) but also a form of a pigment dispersion liquid for preparing the aqueous ink composition.

### (Aqueous Ink Composition for Inkjet and Method for Producing the Same)

The aqueous ink composition of the present embodiment is an aqueous ink including at least the pigment dispersion and an aqueous medium.

### [Pigment Dispersion]

The content of the pigment dispersion is preferably 10 mass % or more and 60 mass % or less based on the entire mass of the aqueous ink composition, more preferably 20 mass % or more and 50 mass % or less, and particularly preferably 30 mass % or more and 40 mass % or less. Owing to setting the content of the pigment dispersion to 10 mass % or more, the coloring power can be improved, and in particular when the content is 30 mass % or more, this effect is more remarkable. In addition, owing to setting the content of the pigment dispersion to 60 mass % or less, dispersibility can be improved, and in particular when the content is 40 mass % or less, this effect is more remarkable.

### [Aqueous Medium]

Examples of the aqueous medium to be used in the aqueous ink composition of the present embodiment include water. As the water, purified water such as ion-exchanged water, ultrafiltration water, reverse osmosis water, or distilled water, or water from which ionic impurities have been removed such as ultrapure water is preferably used.

As the aqueous medium, a mixed solution of water and a water-soluble organic solvent may be used. The water-soluble organic solvent is not particularly limited, and examples thereof specifically include alcohols such as methyl alcohol, ethyl alcohol, n-butyl alcohol, isobutyl alcohol, tert-butyl alcohol, n-propyl alcohol, and isopropyl alcohol; amides such as dimethylformamide and dimethylacetamide; ketones such as acetone and methyl ethyl ketone; ethers such as tetrahydrofuran, dioxane, ethylene glycol methyl ether, ethylene glycol ethyl ether, diethylene glycol methyl ether, diethylene glycol ethyl ether, triethylene glycol monomethyl ether, and triethylene glycol monoethyl ether; polyhydric alcohols such as ethylene glycol, propylene glycol, butylene glycol, diethylene glycol, dipropylene glycol, triethylene glycol, tetraethylene glycol, 1,2,6-hexanetriol, thiodiglycol, polyethylene glycol, polypropylene glycol, glycerin, diglycerin, and polyglycerin; N-methylpyrrolidone, and 1,3-dimethyl-2-imidazolidinone. Among these water-soluble organic solvents, from the viewpoint of improving the ejection property of the aqueous ink composition and preventing the decrease in printing density, polyoxyethylene glycol in which the number of moles of ethylene oxide added is 2 to 4, more specifically, diethylene glycol, triethylene glycol, and tetraethylene glycol are preferable, diethylene glycol and triethylene glycol are more preferable, and triethylene glycol is particularly preferable. The water-soluble organic solvent may be used singly or a mixture of two or more kinds thereof may be used.

The content of the aqueous medium is not particularly limited, but is usually 5 mass % or more and 50 mass % or less, and preferably 5 mass % or more and 45 mass % or less based on the entire mass of the aqueous ink composition. When a mixed solution of water and a water-soluble organic solvent is used as the aqueous medium, the ratio of water to the water-soluble organic solvent is preferably in a range of 10:90 to 50:50, more preferably in a range of 20:80 to 40:60, and still more preferably in a range of 30:70 to 40:60.

### [Additives]

In the aqueous ink composition of the present embodiment, other additives may be blended as long as the effects of the present invention are not impaired. Examples of the additives include a surfactant, a binder, a humectant, a penetrant (penetration controlling agent), a water-soluble resin, a pH adjuster, a chelating agent, an antiseptic, a viscosity modifier, an antifoaming agent, a dispersion stabilizer, a reduction inhibitor, and an antioxidant. The contents of these additives excluding the surfactant, the binder, the humectant, and the penetrant is not particularly limited, and may be appropriately set as necessary (the contents of the surfactant, the binder, the humectant, and the penetrant will be described later).

### 1. Surfactant

The surfactant is not particularly limited, and examples thereof include a fluorine-based surfactant, a silicone-based surfactant, and an acetylene diol-based surfactant. These surfactants may be used singly, or two or more thereof may be used in combination.

The fluorine-based surfactant is not particularly limited, and examples thereof include perfluoroalkyl sulfonic acid compounds, perfluoroalkyl carboxylic acid compounds, perfluoroalkyl phosphoric acid esters, perfluoroalkyl ethylene oxide adducts, perfluoroalkyl betaines, and perfluoroalkyl amine oxide compounds. Examples of commercially available products of the fluorine-based surfactant include F-410, 444, and 553 (trade names, manufactured by DIC Corporation), FS-65, 34, 35, 31, and 30 (trade names, manufactured by Du Pont), and BYK-340 (trade name, manufactured by BYK Japan KK.). These fluorine-based surfactants may be used singly, or two or more thereof may be used in combination.

The silicone-based surfactant is not particularly limited, and examples thereof include polysiloxane-based compounds and polyether-modified organosiloxanes. Examples of commercially available products of the silicone-based surfactant include BYK-306, BYK-307, BYK-333, BYK-341, BYK-345, BYK-346, BYK-347, BYK-348, BYK-349 (trade names, manufactured by BYK Japan KK.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (The above are trade names manufactured by Shin-Etsu Chemical Co., Ltd.). These silicone-based surfactants may be used singly, or two or more thereof may be used in combination.

The acetylene diol-based surfactant is not particularly limited, and examples thereof include a compound having an acetylene diol skeleton and a compound obtained by adding ethylene oxide to an acetylene diol-based compound. Examples of commercially available products of the acetylene diol-based surfactant include SURFYNOL (registered trademark) 104PA, SURFYNOL 420, SURFYNOL 440, SURFYNOL 465 (trade names, manufactured by Air Products and Chemicals, Inc.), OLFINE (registered trademark) E1010 and OLFINE STG (trade names, manufactured by Nissin Chemical Industry Co., Ltd.). These acetylene diol-based surfactants may be used singly, or two or more thereof may be used in combination.

Among the surfactants described above, the silicone-based surfactant and the acetylene diol-based surfactant are preferable from the viewpoint of the ejection property and environmental aspect of the aqueous ink composition.

The content of the surfactant is preferably in a range of 0.1 mass % or more and 5 mass % or less based on the entire mass of the aqueous ink composition, and more preferably in a range of 0.5 mass % or more and 4 mass % or less. When the content of the surfactant is 0.1 mass % or more, ejection failure due to meniscus formation failure or the like in a nozzle in an inkjet head can be prevented when printing is performed in an inkjet system, and occurrence of clogging of the nozzle can be further prevented, and in particular, when the content of the surfactant is 0.5 mass % or more, this effect is more remarkable. Thus, the ejection property can be improved. On the other hand, when the content of the surfactant is 5% by mass or less, it is possible to inhibit the adverse effect on the ejection of the aqueous ink composition due to the insoluble content of the surfactant and emulsification failure, and in particular, when the content of the surfactant is 4% by mass or less, this effect is more remarkable.

### 2. Binder

The binder is not particularly limited, and examples thereof include a polyolefin resin dispersion, a styrene-acrylic acid resin, a styrene-maleic acid resin, and a polyurethane resin. Owing to the inclusion of the binder, it is possible to improve ejection property and to print a print image superior in scratch resistance and water resistance. The styrene-acrylic acid resin, the styrene-maleic acid resin, and the polyurethane resin each function as a binder, and are not blended as a pigment dispersant.

The polyolefin resin dispersion is a resin dispersion in which a polyolefin resin is dispersed in water in the form of an emulsion (latex or dispersion). By adding the polyolefin resin in the form of a resin dispersion of an emulsion to water, the polyolefin resin that does not dissolve in water is prevented from sedimenting. For example, when a powdery polyolefin resin is added to water, a composition in which the polyolefin resin sediments without dissolving in water is formed. As a result, the composition cannot be ejected from an inkjet head, and it is difficult to perform printing in an inkjet system.

The polyolefin resin dispersion of the present embodiment functions as a binder in the aqueous ink composition. By blending the polyolefin resin dispersion, in an ink layer printed using the aqueous ink composition of the present embodiment, for example, the film-forming temperature can be lowered as compared with the case of an aqueous ink composition including only a styrene-acrylic acid resin, a styrene-maleic acid resin, or a polyurethane resin (hereinafter, referred to as “styrene-acrylic acid resin or the like”) as a binder. Thus, the ink layer using the aqueous ink composition of the present embodiment can be sufficiently dried, for example, even when dried at a drying temperature of 80° C. for a drying time of 10 minutes, and therefore is superior in drying property. The scratch resistance under the same drying conditions can also be improved as compared with the case of using only a styrene-acrylic acid resin or the like.

Examples of the polyolefin resin in the polyolefin resin dispersion include anionic polyolefin resins and nonionic polyolefin resins. Among these, the anionic polyolefin resin is preferable in the present invention from the viewpoint of scratch resistance and water resistance.

The anionic polyolefin resin is not particularly limited, and examples thereof include acid-modified polyolefin resins such as maleic anhydride-modified polyolefin resins, chlorinated polyolefin resins, and non-chlorinated polyolefin resins. As the polyolefin resin emulsion, a commercially available product can also be used. Examples of such a commercially available product include HARDLEN (registered trademark) NZ-1004 (solid content concentration: 30 mass %), HARDLEN NZ-1015 (solid content concentration: 30 mass %) (trade names, manufactured by Toyobo Co., Ltd.), ARROWBASE (registered trademark) DA-1010 (solid content concentration: 25 mass %), ARROWBASE DB-4010 (solid content concentration: 25 mass %) (trade names, manufactured by Unitika Ltd.), SUPERCHLON (registered trademark) E-415 (solid content concentration: 30 mass %), SUPERCHLON E-480T (solid content concentration: 30 mass %), and SUPERCHLON E-604 (solid content concentration: 40 mass %) (trade names, manufactured by Nippon Paper Industries Co., Ltd.).

The styrene-acrylic acid resin is not particularly limited, and examples thereof include a polymer containing, in a molecule, at least one styrene-based monomer component selected from the group consisting of styrene and derivatives thereof and at least one acrylic acid-based monomer component selected from the group consisting of (meth)acrylic acid and derivatives thereof as constituent components of the polymer. The styrene-acrylic acid resin may contain a monomer component other than the styrene-based monomer component and the acrylic acid-based monomer component.

The styrene-maleic acid resin is not particularly limited, and examples thereof include a polymer containing, in a molecule, at least one styrene-based monomer component selected from the group consisting of styrene and derivatives thereof and at least one maleic acid-based monomer component selected from the group consisting of maleic acid and derivatives thereof as constituent components of the polymer. The styrene maleic acid resin may contain a monomer component other than the styrene-based monomer component and the maleic acid-based monomer component.

The polyurethane resin is not particularly limited, and examples thereof include polymers containing a polyisocyanate, a polyol, or the like as a constituent component thereof.

When a styrene-acrylic acid resin, a styrene-maleic acid resin, and/or a polyurethane resin is blended, the content thereof is 0.75 mass % or less in terms of solid content based on the entire mass of the aqueous ink composition, preferably 0.6 mass % or less, and more preferably 0.3 mass % or less. Owing to setting the content of the styrene-acrylic acid resin or the like to 0.75 mass % or less in terms of solid content, the film-forming temperature of an ink layer to be formed by printing using the aqueous ink composition of the present embodiment can be inhibited from being excessively high. Thus, good drying properties can be maintained. The scratch resistance can also be improved as compared with the case of using only a styrene-acrylic acid resin or the like. In addition, for example, in the styrene-acrylic acid resin and the styrene-maleic acid resin, an ester linkage in a molecule is easily hydrolyzed, and in the polyurethane resin, a urethane linkage in a molecule is easily hydrolyzed. Therefore, in an aqueous ink composition containing a large amount of these resins, the water resistance and solvent resistance of an ink layer printed using the aqueous ink composition are not good. However, as in the present embodiment, by controlling the content of the styrene-acrylic acid resin and the like to 0.75 mass % or less based on the entire mass of the aqueous ink composition, it is possible to inhibit or prevent the water resistance of the ink layer from deteriorating.

In the present embodiment, the binder preferably consists of the polyolefin resin dispersion. As a result, the film-forming temperature of an ink layer formed of the aqueous ink composition of the present embodiment can be reduced, the ink layer can be sufficiently dried even under normal drying conditions, and the scratch resistance can be further improved. In addition, since the styrene-acrylic acid resin or the like is not contained, the water resistance of the ink layer can be further improved.

The content of the polyolefin resin dispersion is 1.2 mass % or more in terms of solid content based on the entire mass of the aqueous ink composition, preferably 1.5 mass % or more and 6 mass % or less, and more preferably 3 mass % or more and 4.5 mass % or less. Owing to setting the content of the polyolefin resin dispersion in terms of solid content to 1.2 mass % or more, the scratch resistance can be favorably maintained. Owing to setting the content of the polyolefin resin emulsion in terms of solid content to 6 mass % or less, the ejection property of the aqueous ink composition from an inkjet head can be favorably maintained.

### 3. Humectant

The humectant is not particularly limited, and examples thereof include trihydric or higher polyhydric alcohols. The trihydric or higher polyhydric alcohol is not particularly limited, and examples thereof include polyethylene glycol, glycerin, and polyglycerin. Among them, from the viewpoint of preventing drying of a nozzle surface, water-soluble polyhydric alcohols having a high boiling point such as glycerin and polyglycerin are preferable. These humectants may be used singly, or two or more thereof may be used in combination.

The addition amount of the humectant is preferably in a range of 1 mass % or more and 20 mass % or less, and more preferably in a range of 5 mass % or more and 15 mass % or less based on the entire mass of the aqueous ink composition. Owing to setting the content of the humectant to 1 mass % or more, clogging in the vicinity of a nozzle of an inkjet head can be prevented and the ejection performance can be further improved when printing in an inkjet system. This effect is more remarkable in particular when the content of the humectant is 5 mass % or more. On the other hand, owing to setting the content of the humectant to 20 mass % or less, the viscosity of the aqueous ink composition can be appropriately controlled, and in particular, when the content is 15 mass % or less, this effect is more remarkable.

### 4. Penetrant

The penetrant (penetration controlling agent) is not particularly limited, and examples thereof include a glycol solvent having 2 to 5 carbon atoms and a heterocyclic compound. The glycol solvent having 2 to 5 carbon atoms is not particularly limited, and examples thereof include ethylene glycol and propylene glycol. The heterocyclic compound is not particularly limited, and examples thereof include nitrogen-containing heterocyclic compounds such as 2-pyrrolidone, N-methyl-2-pyrrolidone, and N-hydroxyethyl-2-pyrrolidone. The penetrants (penetration controlling agent) s recited above as examples may be used singly, or two or more thereof may be used in combination.

The addition amount of the penetrant (penetration controlling agent) is preferably in a range of 1 mass % or more and 20 mass % or less, and more preferably in a range of 5 mass % or more and 15 mass % or less based on the entire mass of the aqueous ink composition. Owing to setting the content of the penetrant (penetration controlling agent) to 1 mass % or more, sufficient penetrability of the aqueous ink composition to a recording medium can be maintained, and in particular, when the content is 5 mass % or more, this effect is more remarkable. On the other hand, owing to setting the content of the penetrant (penetration controlling agent) to 20 mass % or less, the coloring material excessively penetrates a recording medium and does not remain in a surface layer portion, and the printing density of a print image can be inhibited from decreasing. Furthermore, the viscosity of the aqueous ink composition can be inhibited from becoming excessively high, and the stability of the aqueous ink composition can also be maintained. These effects are more remarkable particularly at 15 mass % or less.

### 5. pH Adjuster

The pH adjuster is added for the purpose of adjusting the pH of the aqueous ink composition. The pH adjuster is not particularly limited, and examples thereof include inorganic acids such as sulfuric acid, hydrochloric acid, and nitric acid; inorganic bases such as lithium hydroxide, sodium hydroxide, potassium hydroxide, and ammonia; organic bases such as triethanolamine, diethanolamine, monoethanolamine, triisopropanolamine, diisopropanolamine, and trishydroxymethylaminomethane; and organic acids such as adipic acid, citric acid, succinic acid, and lactic acid. The pH adjusters recited above as examples may be used singly, or two or more thereof may be used in combination.

### [Others]

The viscosity of the aqueous ink composition of the present embodiment is, in consideration of the ejection property from an inkjet nozzle, preferably 3 mPa·s to 6 mPa·s at the time of ejection from the inkjet nozzle, and more preferably 3.5 mPa·s to 5.7 mPa·s. Owing to setting the viscosity of the aqueous ink composition in the above numerical range, the occurrence of clogging in an inkjet nozzle can be further inhibited, and good ejection property is maintained. The viscosity of the aqueous ink composition can be measured at a measurement temperature of 25° C. using, for example, a viscometer (trade name: VISCOMATE MODEL VM-10A, manufactured by Sekonic Corporation).

The aqueous ink composition of the present embodiment can be used as an aqueous ink composition capable of forming a print image by forming an ink layer on a surface of a recording medium. In addition, the aqueous ink composition of the present embodiment not only can be one contained in an aqueous ink for inkjet, which is a final product, but also can be used as received as an aqueous ink for inkjet.

### [Method for Producing Aqueous Ink Composition for Inkjet]

The aqueous ink composition of the present embodiment can be produced by mixing the above-described components by an appropriate method. That is, for example, the above-described additives and the like are added to the pigment dispersion, and the mixture is further diluted with an aqueous medium. Thereafter, the mixture is sufficiently stirred, and filtration for removing coarse particles and foreign matters that cause clogging is performed as necessary. Thus, the aqueous ink composition according to the present embodiment can be obtained.

The method for mixing the materials is not particularly limited, and for example, the materials are sequentially added to a container equipped with a stirring device such as a mechanical stirrer or a magnetic stirrer, and then stirred and mixed. The filtration method is not particularly limited, and for example, centrifugal filtration or filter filtration may be adopted.

### (Recording Medium)

The recording medium is not particularly limited, and a conventionally known recording medium may be adopted. Examples thereof specifically include printing paper such as coated paper, art paper and mat paper, and a film.

### EXAMPLES

Hereinafter, preferred embodiments of the present invention will be exemplarily described in detail. However, as to the materials, contents, etc. described in the following Examples, the scope of the present invention is not limited only to them unless otherwise limited.

### Example 1

In this example, 19.2 g of C.I. Pigment Red 122 (PR122, Cinquasia (registered trademark) Magenta D4550 J, manufactured by BASF Japan Ltd.) as a magenta pigment, 5.16 g of an acrylic dispersant (trade name: DISPERBYK-2015, manufactured by BYK-Chemie GmbH; acid value: 10 mg KOH/g), and 7.2 g of propylene glycol were added to a container, and 88.44 g of pure water was further added thereto. Subsequently, the mixed liquid in the container was dispersed with a dispersing machine (paint shaker, manufactured by Asada Iron Works Co., Ltd.) at normal temperature for 2 hours (dispersion time). The dispersion was performed by mixing 210 g of zirconia beads (average particle diameter: 0.5 mm). Thus, a pigment dispersion A according to this example was prepared. The content of the acrylic dispersant based on the magenta pigment was set to 26.875 mass %.

### Example 2

In this example, 18 g of C.I. Pigment Violet 19 (PV19, Cinquasia (registered trademark) Red L 4105 HD, manufactured by BASF Japan Ltd.) as a magenta pigment, 6.6 g of an acrylic dispersant (trade name: DISPERBYK-2015, manufactured by BYK-Chemie GmbH; acid value: 10 mg KOH/g), and 7.2 g of propylene glycol were added to a container, and 88.2 g of pure water was further added thereto. Subsequently, the mixed liquid in the container was dispersed with a dispersing machine (paint shaker, manufactured by Asada Iron Works Co., Ltd.) at normal temperature for 2 hours (dispersion time). The dispersion was performed by mixing 210 g of zirconia beads (average particle diameter: 0.5 mm). Thus, a pigment dispersion B according to this example was prepared. The content of the acrylic dispersant based on the magenta pigment was set to 36.667 mass %.

### Example 3

In this example, the content of the acrylic dispersant as a pigment dispersant was changed to 3.6 g, and the content of pure water was changed to 90 g. Except for these, a pigment dispersion C according to this example was produced in the same manner as in Example 1. The content of the pigment dispersant based on the magenta pigment was set to 18.75 mass %.

### Example 4

In this example, 18 g of C.I. Pigment Violet 19 (PV19, Cinquasia (registered trademark) Red L 4105 HD, manufactured by BASF Japan Ltd.) as a magenta pigment, 3.6 g of an acrylic dispersant (trade name: DISPERBYK-2015, manufactured by BYK-Chemie GmbH; acid value: 10 mg KOH/g), and 7.2 g of propylene glycol were added to a container, and 91.2 g of pure water was further added thereto. Subsequently, the mixed liquid in the container was dispersed with a dispersing machine (paint shaker, manufactured by Asada Iron Works Co., Ltd.) at normal temperature for 2 hours (dispersion time). The dispersion was performed by mixing 210 g of zirconia beads (average particle diameter: 0.5 mm). Thus, a pigment dispersion D according to this example was prepared. The content of the acrylic dispersant based on the magenta pigment was set to 20 mass %.

### Example 5

In this example, 15 g of C.I. Pigment Violet 19 (PV19, Cinquasia (registered trademark) Red L 4105 HD, manufactured by BASF Japan Ltd.) as a magenta pigment, 9.5 g of DISPERBYK-194N (trade name, manufactured by BYK-Chemie GmbH; acid value: 75 mg KOH/g), and 7.2 g of propylene glycol were added to a container, and 68.3 g of pure water was further added thereto. Subsequently, the mixed liquid in the container was dispersed with a dispersing machine (paint shaker, manufactured by Asada Iron Works Co., Ltd.) at normal temperature for 2 hours (dispersion time). The dispersion was performed by mixing 175 g of zirconia beads (average particle diameter: 0.5 mm). Thus, a pigment dispersion E according to this example was prepared. The content of the DISPERBYK-194N based on the magenta pigment was set to 63.3 mass %.

### Example 6

In this example, a polyvinyl alcohol-polyacrylic acid copolymer (trade name: DISPERBYK-2096, manufactured by BYK-Chemie GmbH; acid value: 40 mg KOH/g) was used in place of DISPERBYK-194N, and the content thereof was changed to 0.1 g. In addition, the content of pure water was changed to 77.7 g. Except for these, a pigment dispersion F according to this example was produced in the same manner as in Example 13. The content of the pigment dispersant based on the magenta pigment was set to 0.7 mass %.

### Comparative Example 1

In this comparative example, 16 g of C.I. Pigment Red 122 (PR122, Cinquasia (registered trademark) Magenta D4550 J, manufactured by BASF Japan Ltd.) as a magenta pigment, 0.8 g of a pigment dispersant (trade name: DISPERBYK-193, manufactured by BYK-Chemie GmbH; having no acid value, having no amine value), and 7.2 g of propylene glycol were added to a container, and 76 g of pure water was further added thereto. Subsequently, the mixed liquid in the container was dispersed with a dispersing machine (paint shaker, manufactured by Asada Iron Works Co., Ltd.) at normal temperature for 2 hours (dispersion time). The dispersion was performed by mixing 175 g of zirconia beads (average particle diameter: 0.5 mm). However, in this comparative example, the magenta pigment aggregated into a paste, and no pigment dispersion was obtained. The content of the pigment dispersant based on the magenta pigment was set to 5.0 mass %.

### Comparative Example 2

In this comparative example, DISPERBYK-2061 (trade name, manufactured by BYK-Chemie GmbH, amine value: 3 mg KOH/g) was used in place of DISPERBYK-193, and the content thereof was changed to 4 g. In addition, the content of pure water was changed to 72.8 g. Except for these, a pigment dispersion G according to this comparative example was produced in the same manner as in Comparative Example 1. The content of the pigment dispersant based on the magenta pigment was set to 25 mass %.

### Comparative Example 3

In this comparative example, DISPERBYK-2055 (trade name, manufactured by BYK-Chemie GmbH, amine value: 40 mg KOH/g) was used in place of DISPERBYK-193, and the content thereof was changed to 3.5 g. In addition, the content of pure water was changed to 73.3 g. Except for these, a pigment dispersion H according to this comparative example was produced in the same manner as in Comparative Example 1. The content of the pigment dispersant based on the magenta pigment was set to 21.9 mass %.

### Comparative Example 4

In this comparative example, C.I. Pigment Violet 19 (PV19, Cinquasia (registered trademark) Red L4105 HD, manufactured by BASF Japan Ltd.) was used as a magenta pigment, and the content thereof was changed to 15 g. In addition, the content of pure water was changed to 77 g. Except for these, a pigment dispersion I according to this comparative example was produced in the same manner as in Comparative Example 1. The content of the pigment dispersant based on the magenta pigment was set to 5.3 mass %.

### Comparative Example 5

In this comparative example, DISPERBYK-2061 (trade name, manufactured by BYK-Chemie GmbH, amine value: 3 mg KOH/g) was used in place of DISPERBYK-193, and the content thereof was changed to 4 g. In addition, the content of pure water was changed to 73.8 g. Except for these, a pigment dispersion J according to this comparative example was produced in the same manner as in Comparative Example 4. The content of the pigment dispersant based on the magenta pigment was set to 26.7 mass %.

### Comparative Example 6

In this comparative example, DISPERBYK-2055 (trade name, manufactured by BYK-Chemie GmbH, amine value: 40 mg KOH/g) was used in place of DISPERBYK-193, and the content thereof was changed to 3.5 g. In addition, the content of pure water was changed to 74.3 g. Except for these, a pigment dispersion K according to this comparative example was produced in the same manner as in Comparative Example 1. The content of the pigment dispersant based on the magenta pigment was set to 23.3 mass %.

TABLE 1

| | | | Example | Example | Example | Example | Example | Example |
|---|---|---|---|---|---|---|---|---|
| | | | 1 | 2 | 3 | 4 | 5 | 6 |
| Type of pigment dispersion | | | A | B | C | D | E | F |
| Magenta | Cinquasia Magenta D4550 J | | 19.2 | — | 19.2 | — | — | — |
| pigment | Cinquasia Red L4105 HD | | — | 18 | — | 18 | 15 | 15 |
| Pigment | DISPERBYK- | Acid value: 10 mg | 5.16 | 6.6 | 3.6 | 3.6 | — | — |
| dispersant | 2015 | KOH/g | | | | | | |
| | DISPERBYK- | Acid value: 75 mg | — | — | — | — | 9.5 | — |
| | 194N | KOH/g | | | | | | |
| | DISPERBYK- | Acid value: 40 mg | — | — | — | — | — | 0.1 |
| | 2096 | KOH/g | | | | | | |
| | DISPERBYK193 | No acid value | — | — | — | — | — | — |
| | | No amine value | | | | | | |
| | DISPERBYK- | Amine value: 3 | — | — | — | — | — | — |
| | 2061 | mg KOH/g | | | | | | |
| | DISPERBYK- | Amine value: 40 | — | — | — | — | — | — |
| | 2055 | mg KOH/g | | | | | | |

| | | | | | | |
|---|---|---|---|---|---|---|
| Propylene glycol | 7.2 | 7.2 | 7.2 | 7.2 | 7.2 | 7.2 |
| Pure water | 88.44 | 88.2 | 90 | 91.2 | 68.3 | 77.7 |

| | | | | | | |
|---|---|---|---|---|---|---|
| Total (g) | 120 | 120 | 120 | 120 | 100 | 100 |
| Presence or absence of dispersion | ∘ | ∘ | ∘ | ∘ | ∘ | ∘ |

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Type of pigment dispersion | | | — | G | H | I | J | K |
| Magenta | Cinquasia Magenta D4550 J | | 16 | 16 | 16 | — | — | — |
| pigment | Cinquasia Red L4105 HD | | — | — | — | 15 | 15 | 15 |
| Pigment | DISPERBYK- | Acid value: 75 mg | — | — | — | — | — | — |
| dispersant | 194N | KOH/g | | | | | | |
| | DISPERBYK- | Acid value: 40 mg | — | — | — | — | — | — |
| | 2096 | KOH/g | | | | | | |
| | DISPERBYK193 | No acid value | 0.8 | — | — | 0.8 | — | — |
| | | No amine value | | | | | | |
| | DISPERBYK- | Amine value: 3 | — | 4 | — | — | 4 | — |
| | 2061 | mg KOH/g | | | | | | |
| | DISPERBYK- | Amine value: 40 | — | — | 3.5 | — | — | 3.5 |
| | 2055 | mg KOH/g | | | | | | |

| | | | | | | |
|---|---|---|---|---|---|---|
| Propylene glycol | 7.2 | 7.2 | 7.2 | 7.2 | 7.2 | 7.2 |
| Pure water | 76 | 72.8 | 73.3 | 77 | 73.8 | 74.3 |

| | | | | | | |
|---|---|---|---|---|---|---|
| Total (g) | 100 | 100 | 100 | 100 | 100 | 100 |
| Presence or absence of dispersion | × | ∘ | ∘ | ∘ | ∘ | ∘ |

### Examples 7 to 11

In Examples 7 to 11, the aqueous ink compositions for inkjet (hereinafter referred to as “aqueous ink compositions”) according to the respective Examples were prepared using the pigment dispersions shown in Table 3 and adding other additives so as to have the blending ratios shown in Table 4.

### Comparative Examples 7 to 10

In Comparative Examples 7 to 10, the aqueous ink compositions according to the respective Comparative Examples were prepared using the pigment dispersion shown in Table 3 and adding other additives so as to have the blending ratios shown in Table 4.

TABLE 3

| | Example | Example | Example | Example | Example |
|---|---|---|---|---|---|
| | 7 | 8 | 9 | 10 | 11 |
| Type of pigment | A | C | D | E | F |
| dispersion | | | | | |

| | Com- | Com- | Com- | Com- |
|---|---|---|---|---|
| | parative | parative | parative | parative |
| | Example 7 | Example 8 | Example 9 | Example 10 |
| Type of pigment | I | J | K | G |
| dispersion | | | | |

TABLE 4

| | | Blending |
|---|---|---|
| Component | | amount (g) |
| Surfactant | SURFYNOL 104PA (NV = 50) | 0.50 |
| | SURFYNOL 465 | 1.20 |
| Aqueous medium | Propylene glycol | 7.00 |
| Humectant | Purified glycerin | 3.90 |
| Solvent | 1,2-Hexanediol | 2.60 |
| Penetrant | 2-Pyrrolidone | 3.40 |
| Water-soluble | Triethylene glycol | 3.60 |
| organic solvent | | |
| pH adjuster | Triethanolamine | 0.50 |
| Pure water | | 36.80 |
| Anionic polyolefin resin | HARDLEN NZ-1004 | 3.00 |

| | |
|---|---|
| Pigment dispersion | 37.50 |
| Total | 100.00 |

### (Evaluation of Print Image)

The aqueous ink compositions of Examples 7 and 9 to 11 and Comparative Example 7 to 10 were subjected to color gamut evaluation and magenta saturation evaluation by the following methods.

Using each of the aqueous ink compositions, printing was applied onto inkjet high-quality paper in an inkjet system. Specifically, printing was performed by a single pass (one pass) system using an inkjet printer (trade name: PX-105, manufactured by Epson Corporation).

Next, the values of L*, a*, and b* in the L*a*b* color system were measured for the images printed on the samples of Examples and Comparative Examples, respectively, using a color difference meter (Model number: X-Rite eXact, manufactured by X-Rite, Inc.). The magenta saturation (C*) was calculated by the following formula (JIS Z 8729) on the basis of the measured value of the color characteristics.

$${C}^{*} = {\{ ( {a}^{* 2} ) + ( {b}^{* 2} ) \}}^{1 / 2}$$

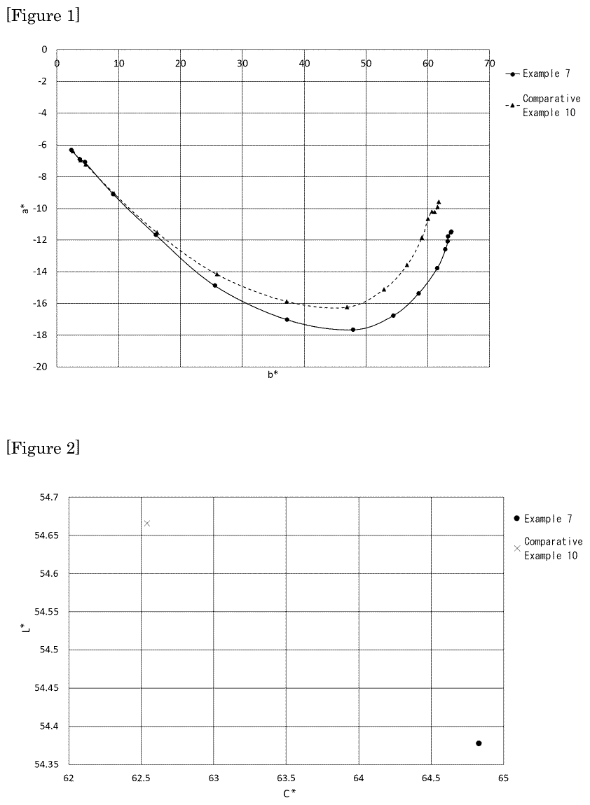

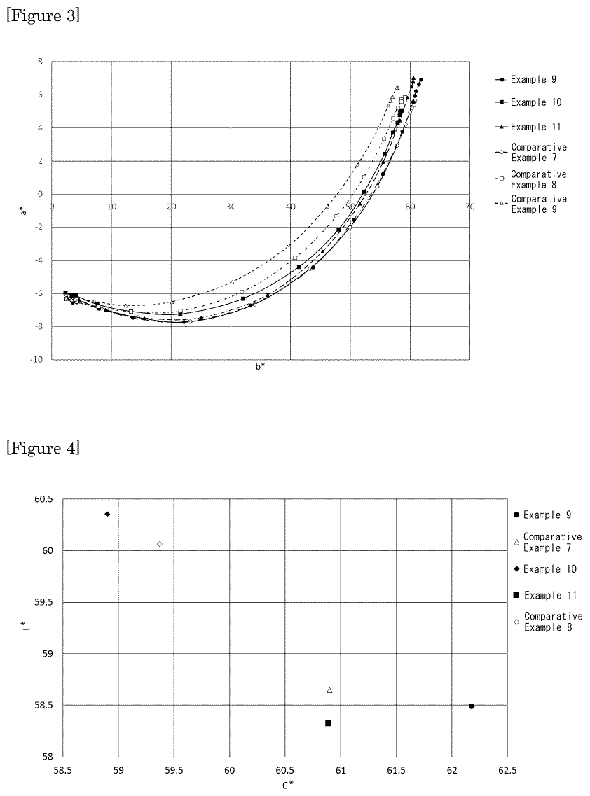

In the L*a*b* color system, brightness is represented by L*, and hue and saturation are represented by a* and b*. Regarding the evaluation of the magenta saturation, it can be said that the larger the value of C*, the better the saturation of the print image. The results are shown in FIGS. 1 to 4. FIG. 1 is an L*a*b* color system chromaticity diagram of the print images produced using the aqueous ink compositions according to Example 7 and Comparative Example 10. FIG. 2 is a graph showing the measured values (L*, C*) of the print images produced using the aqueous ink compositions according to Example 7 and Comparative Example 10. FIG. 3 is an L*a*b* color system chromaticity diagram of the print images produced using the aqueous ink compositions according to Examples 9 to 11 and Comparative Examples 7 to 9. FIG. 4 is a graph showing the measured values (L*, C*) of the print images produced using the aqueous ink compositions according to Examples 9 to 11 and Comparative Examples 7 and 8.

As can be seen from FIGS. 1 and 3, in the print images produced using the aqueous ink compositions according to Examples, the hue and the saturation were good, and the print density was high. In particular, with the aqueous ink compositions according to Examples 7, 9, and 11 using the pigment dispersant having an acid value of 10 mg KOH/g or 40 mg KOH/g and having no amine value, it was confirmed that the print density was high and the reduction of the gamut due to aggregation was inhibited as compared with the aqueous ink compositions according to Comparative Examples 8 to 10 using the pigment dispersants having no acid value.

In addition, as can be seen from FIGS. 2 and 4, in the print images using the aqueous ink compositions according to the respective Examples, the brightness L* and the saturation C* exhibited good values. In particular, the aqueous ink compositions according to Examples 7, 9, and 11 using the pigment dispersants having an acid value of 10 mg KOH/g or 40 mg KOH/g and having no amine value were confirmed to have better magenta saturation as compared with the aqueous ink compositions according to Comparative Examples 7 and 8 using the pigment dispersants having no acid value.

1. A pigment dispersant for dispersing a magenta pigment,
in which a copolymer composed of a polymer alcohol and an ester, or an acrylic dispersant is dispersed in a dispersion medium, and
the copolymer composed of the polymer alcohol and the ester, and the acrylic dispersant have an acid value.

2. The pigment dispersant according to claim 1, wherein the copolymer composed of a polymer alcohol and an ester, and the acrylic dispersant have no amine value.

3. The pigment dispersant according to claim 1, wherein acid values of the copolymer composed of a polymer alcohol and an ester, and the acrylic dispersant are 10 mg KOH/g or more and 40 mg KOH/g or less.

4. The pigment dispersant according to claim 1, wherein the copolymer composed of a polymer alcohol and an ester is a polyvinyl alcohol-polyacrylic acid copolymer.

5. The pigment dispersant according to claim 4, wherein the polyvinyl alcohol-polyacrylic acid copolymer is DISPERBYK (registered trademark)-2096.

6. The pigment dispersant according to claim 1, wherein the acrylic dispersant is DISPERBYK (registered trademark)-2015.

7. A pigment dispersion comprising:
the pigment dispersant according to claim 1, and
the magenta pigment dispersed in the dispersion medium.

8. The pigment dispersion according to claim 7, wherein the magenta pigment includes a quinacridone pigment.

9. The pigment dispersion according to claim 8, wherein the quinacridone pigment includes at least one of C.I. Pigment Red 122 and C.I. Pigment Violet 19.

10. An aqueous ink composition for inkjet comprising the pigment dispersion according to claim 7.

11. The aqueous ink composition for inkjet according to claim 10, further comprising a humectant,
wherein the humectant includes at least one of a trihydric or higher polyhydric alcohol and a glycol solvent.

12. The aqueous ink composition for inkjet according to claim 10, further comprising a penetrant,
wherein the penetrant includes at least one of a glycol ether and a heterocyclic compound.

13. The pigment dispersant according to claim 1, wherein a content of the copolymer composed of a polymer alcohol and an ester, or the acrylic dispersant are 50 mass % or more and 100 mass % or less based on the entire mass of the pigment dispersant.

14. The pigment dispersion according to claim 7, wherein a content of the copolymer composed of a polymer alcohol and an ester, or the acrylic dispersant is 1 mass % or more and 50 mass % or less based on 100 mass % of the magenta pigment.

15. The aqueous ink composition for inkjet according to claim 10, further comprising a binder,
